(19) United States
(12) Patent Application Publication
(10) Pub. No.: US 2007/0294106 A1
(43) Pub. Date: Dec. 20, 2007

(54) System And Method For Configuring Clinical Care Setting Per Patient According To Clinical Guidelines

(75) Inventor: Yasser Alsafadi, Yorktown Heights, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,466

(22) PCT Filed: Aug. 5, 2005
(86) PCT No.: PCT/IB05/52618

§ 371 Date: Feb. 9, 2007

Related U.S. Application Data
(60) Provisional application No. 60/600,245, filed on Aug. 10, 2004.

(51) Int. Cl. G06Q 50/00; G06F 19/00

(52) U.S. Cl. 705/2; 707/1

(57) ABSTRACT

A system and method for configuring a clinical setting for a particular patient according to a clinical guideline prescribed for the particular patient are provided. The system (200) includes at least one contactless reader (404) for detecting a first tag associated with a patient (416) and generating a first identification signal indicative of the first tag; and a processor (302) for receiving the first identification signal, retrieving a patient record based on the first identification signal and generating a clinical care setting configuration for the patient based on the patient record. Additionally, the reader detects at least one second tag associated with at least one piece of medical equipment (408, 412) and the processor determines a current care setting configuration based on the detected at least one second tag, and then determines if the generated care setting configuration matches the current care setting configuration.

The present disclosure relates generally to data processing and decision systems, and more particularly, to a system and method for configuring clinical care settings per patient according to clinical guidelines.

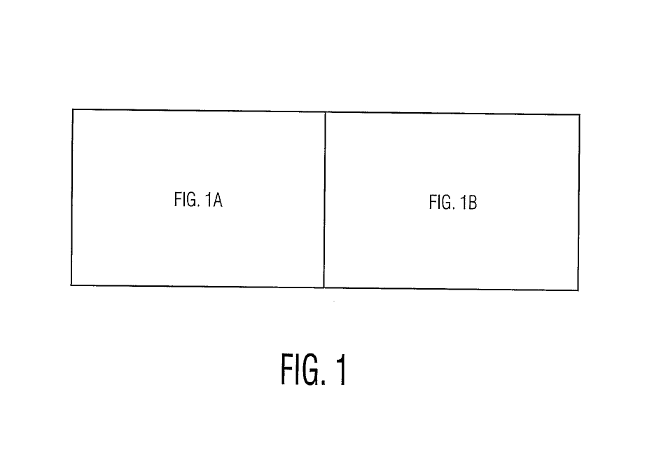

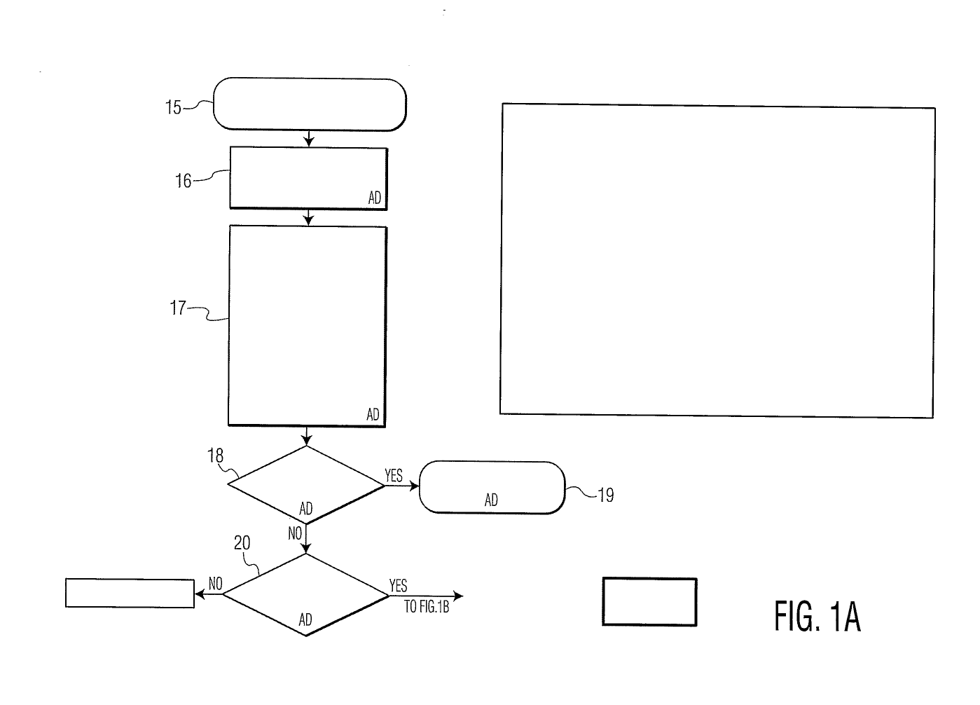

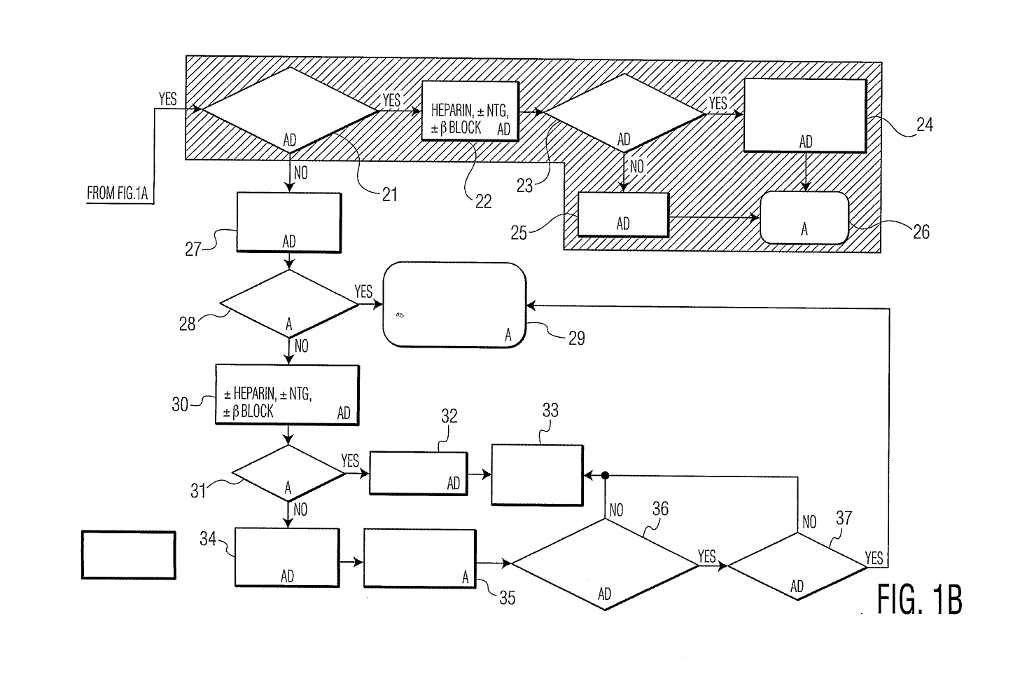

Limited financial resources and increasing emphasis on primary care in a managed care environment are driving medical care delivery to become more efficient and cost-effective without sacrificing quality. One major approach to achieving the goals of efficiency and quality is through the standardization of care for specific diseases. Care standardization efforts have included development of care maps, critical pathways, and care guidelines. An example of a clinical guideline is depicted in FIG. 1.

In recent years, the availability of more efficient, reliable and cost-effective computers in the field of health care has resulted in the development of computer-based clinical decision support systems. Furthermore, electronic medical records have provided an opportunity to invoke guidelines during the everyday practice of clinical medicine to improve health care quality and control costs. Studies have shown that computer-based implementation of clinical practice guidelines, when integrated with clinical workflow to provide patient specific recommendations at points of care, can improve clinician performance and patient outcomes.

As patient treatment proceeds according to a clinical guideline, medical equipment and devices may not be available to provide the needed care. The problem is to configure the care location with the proper equipment, needed for the particular patient, who is being treated according to the specific guideline.

Therefore, a need exists for techniques for configuring a clinical care setting for a particular patient according to a prescribed clinical guideline. Furthermore, these techniques should be easy to implement by the clinical staff and require little user-intervention.

A system and method for configuring a clinical setting for a particular patient according to a clinical guideline prescribed for the particular patient are provided.

According to an aspect of the present disclosure, a method for configuring a clinical care setting for at least one patient is provided. The method includes the steps of retrieving a clinical guideline prescribed for the at least one patient; determining a care setting configuration based on the retrieved clinical guideline; comparing the determined care setting configuration with a current care setting configuration of the at least one patient; and proposing alternate care setting if the determined care setting configuration does not match the current care setting configuration of the at least one patient. The retrieving a clinical guideline step includes the steps of obtaining an identification of the at least one patient; retrieving a data record of the at least one patient based on the patient identification; and determining the clinical guideline prescribed for the at least one patient based on the patient record.

In another aspect, the obtaining step may include detecting a user-specific tag having a unique user identification code, wherein the user-specific tag is a radio frequency identification (RFID) tag, scanning a barcode having a unique user identification code or employing face identification technology via computer vision.

The method further includes the step of obtaining the current care setting configuration by detecting at least one tag associated with at least one piece of medical equipment, wherein the at least one tag is a radio frequency identification (RFID) tag, scanning a barcode associated with at least one piece of medical equipment or employing object identification technology via computer vision.

In a further aspect, the method includes the step of generating a work order for required equipment based on the determined configuration.

In another aspect of the present disclosure, a system for configuring a clinical care setting for at least one patient includes at least one contactless reader for detecting a first tag associated with a patient and generating first identification signal indicative of the first tag; and a processor for receiving the first identification signal, retrieving a patient record based on the first identification signal and generating a clinical care setting configuration for the patient based on the patient record. The system further includes a clinical guideline database for storing a plurality of clinical guidelines, and wherein the processor retrieves a prescribed clinical guideline for the patient based on the patient record; and a care setting configuration database, and wherein the processor determines a current step of the clinical guideline for the patient based on the patient record and generates the clinical care setting based on the current step of the clinical guideline.

In another aspect, the at least one reader detects at least one second tag associated with at least one piece of medical equipment and the processor determines a current care setting configuration based on the detected at least one second tag, and wherein the processor determines if the generated care setting configuration matches the current care setting configuration. The first and at least one second tags may radio frequency identification (RFID) tags and/or global positioning system (GPS) tags. Alternatively, the tags may be barcode labels.

The system may include an ordering system for ordering necessary medical equipment if the processor determines the generated care setting configuration does not match the current care setting configuration and/or a scheduling system for scheduling rearrangement of necessary medical equipment if the processor determines the generated care setting configuration does not match the current care setting configuration.

In still a further aspect of the present disclosure, a program storage device readable by a machine, tangibly embodying a program of instructions executable by the machine to perform method steps for configuring a clinical care setting for at least one patient is provided, the method steps comprising retrieving a clinical guideline prescribed for the at least one patient; determining a care setting configuration based on the retrieved clinical guideline; comparing the determined care setting configuration with a current care setting configuration of the at least one patient; and proposing an alternate care setting if the determined care setting configuration does not match the current care setting configuration of the at least one patient.

The above and other aspects, features, and advantages of the present disclosure will become more apparent in light of the following detailed description when taken in conjunction with the accompanying drawings in which:

FIG. 1 is a flowchart illustrating an exemplary clinical guideline for the treatment of acute myocardial infarction;

FIG. 2 is a flow diagram of the system and method for configuring a clinical care setting per patient according to clinical guidelines in accordance with an embodiment of the present disclosure;

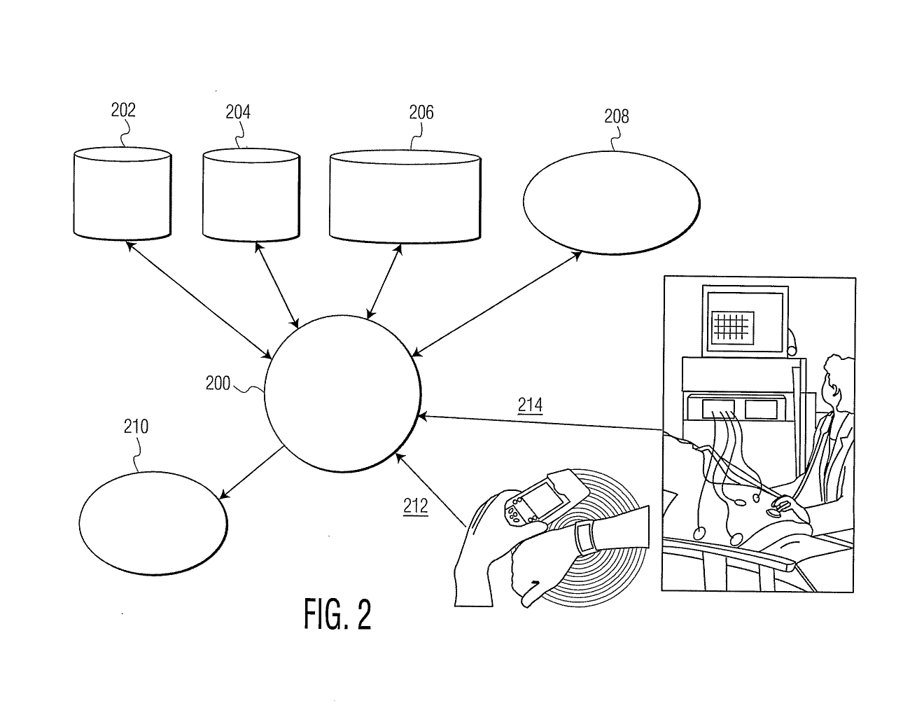

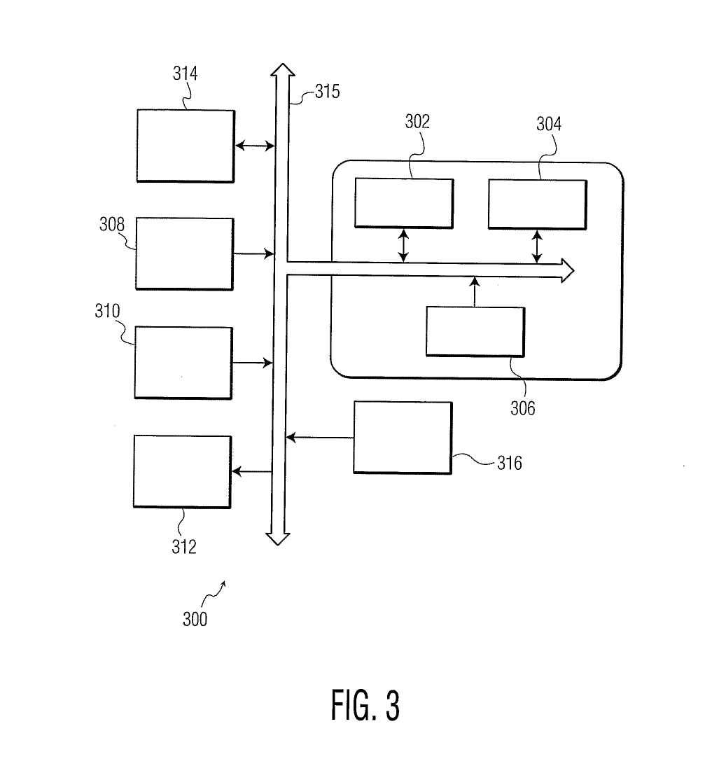

FIG. 3 is an exemplary computer for use in the system shown in FIG. 2;

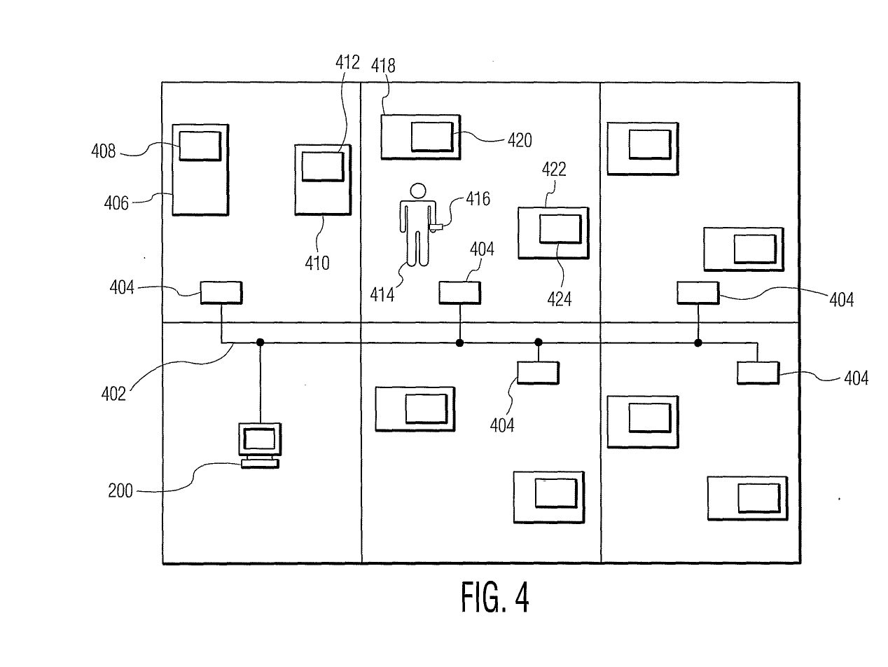

FIG. 4 is a block diagram of a system for configuring a clinical setting; and

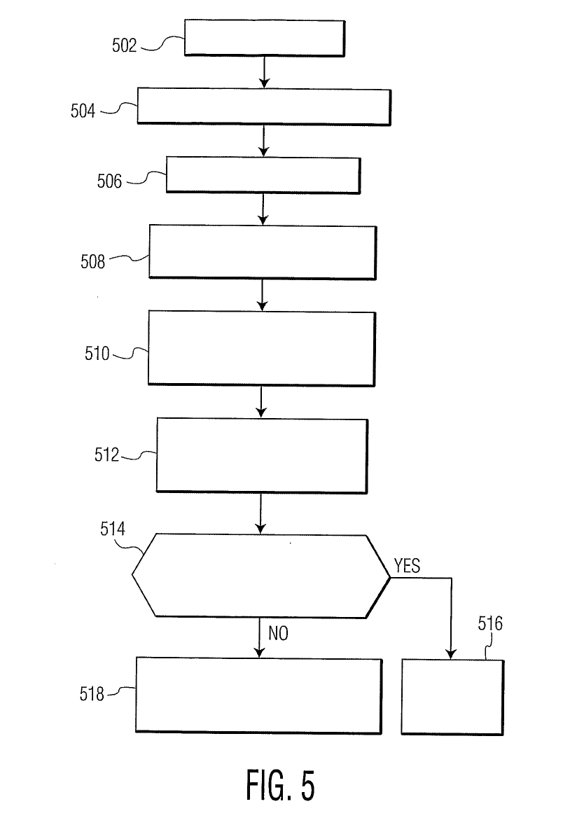

FIG. 5 is a flow chart illustrating a method for configuring a clinical setting in accordance with an embodiment of the present disclosure.

Preferred embodiments of the present disclosure will be described hereinbelow with reference to the accompanying drawings. In the following description, well-known functions or constructions are not described in detail to avoid obscuring the present disclosure in unnecessary detail.

A system and method for configuring a clinical setting for a particular patient according to a clinical guideline prescribed for the particular patient are provided. The system and method of the present disclosure will determine the status of a patient, determine their progress in relation to a prescribed clinical guideline, determine the proper setting for the patient at the determined stage, e.g., equipment, staffing, medications, etc., and either determine the current setting of the patient is satisfactory or configure a new setting and subsequently schedule the proper requirements. The system and method is able to detect the current configuration of the care setting and locations of requirements, with minimal user intervention.

Referring to FIG. 2, an overall system and information flow diagram according to the present disclosure is illustrated. The care setting configuration system 200 includes a plurality of databases, e.g., a patient record database 202, a clinical guideline database 204, a care setting configuration database 206 and a domain knowledge database 208; a ordering/scheduling system 210; and a plurality of interfaces for inputting patient id's 212 and determining existing configurations 214. Generally, a user will input a patient id, e.g., wirelessly, to the configuration system 200 which will retrieve the patient's record from patient database 202. The configuration system 202 will then retrieve a clinical guideline prescribed for the patient from the clinical guideline database 204 and determine what stage the patient is currently at. Based on the stage of the patient, the configuration system 200 will interact with the care setting configuration database 206 to determine the optimal care setting configuration. Through interface 214, e.g., a wireless RFID reader, a barcode scanner, etc., the configuration system 200 will determine the current care configuration of the patient and compare it to the determined configuration. If the comparison is satisfactory, no further action will be taken. If the comparison is not satisfactory, the configuration system 200 will determine the proper requirements and send this information to the ordering/scheduling system 210, which in turn will generate work orders for equipment, supplies, personnel, etc. to properly configure the patient's setting, e.g., hospital room. The domain knowledge base 208 enables the system 200 to translate the terms used in different systems and/or databases (e.g., patient record database 202, clinical guideline database 204, care setting configuration database 206, and ordering/scheduling system 210).

It is to be understood that the present disclosure may be implemented in various forms of hardware, software, firmware, special purpose processors, or a combination thereof. In one embodiment, the present disclosure may be implemented in software as an application program tangibly embodied on a program storage device. The application program may be uploaded to, and executed by, a machine comprising any suitable architecture such as personal computer, a workstation or server. Referring to FIG. 3, preferably, the machine 300 is implemented on a computer platform having hardware such as one or more central processing units (CPU) 302, a random access memory (RAM) 304, a read only memory (ROM) 306 and input/output (I/O) interface(s) such as a keyboard 308, cursor control device 310 (e.g., a mouse or joystick) and display device 312. A system bus 315 couples the various components and may be any of several types of bus structures including a memory bus or memory controller, a peripheral bus, and a local bus using any of a variety of bus architectures. The computer platform also includes an operating system and micro instruction code. The various processes and functions described herein may either be part of the micro instruction code or part of the application program (or a combination thereof) which is executed via the operating system.

In addition, various other peripheral devices may be connected to the computer platform by various interfaces and bus structures, such a parallel port, serial port or universal serial bus (USB). One such peripheral device may include a wireless access point or RF (radio frequency) reader 316 for inputting patient id's, or determining existing care setting configurations and/or locations of equipment, supplies, etc. Other peripheral devices may include additional storage devices and a printer.

It is to be further understood that, because some of the constituent system components and method steps depicted in the accompanying figures may be implemented in software, the actual connections between the system components (or the process steps) may differ depending upon the manner in which the present disclosure is programmed. Given the teachings of the present disclosure provided herein, one of ordinary skill in the related art will be able to contemplate these and similar implementations or configurations of the present disclosure.

The computer 300 may operate in a networked environment using logical connections to one or more remote computers. The remote computer may be a personal computer, a server, a router, a network PC, a peer device or other common network node, and typically includes many or all of the elements described above relative to the computer. It is to be appreciated that the network may be a local area network (LAN), wide area network (WAN), the Internet or any known network that couples a plurality of computers to enable various modes of communication via network messages. For example, the system may be a corporate intranet including a single server and multiple personal computers housed within a single facility, or alternatively, multiple servers with multiple personal computers located in various geographic locations.

An exemplary embodiment in accordance with the present disclosure will now be described in relation to FIGS. 4 and 5, where FIG. 4 is block diagram of a system for configuring a clinical setting for a particular patient according to a prescribed clinical guideline and FIG. 5 is a flow chart illustrating a method for configuring the clinical setting.

Referring to FIG. 4, the care setting configuration system 200 is employed in a hospital setting including a plurality of patient rooms. The configuration system 200 is coupled to a plurality of wireless or contactless readers 404 via communication bus 402 communicating on a serial interface protocol. Throughout the facility, each piece of equipment, e.g., defibulator 406, EKG machine 410, etc., includes a smart label 408, 412, e.g., a radio frequency identification (RFID) tag, which includes a unique identification for the piece of equipment. An exemplary tag and corresponding reader are the I-CODE1 label and reader commercially available from Philips Semiconductor of Eindhoven, The Netherlands, the assignee of the present application. It is to be appreciated that although one reader 404 is shown in each patient room this configuration is not to be construed as limiting since the number of readers 404 will depend on the range of the reader. For long-range readers, for example, capable of reading from about 10 feet to about 22 feet away from a tag, the reader may cover several rooms and be capable of reading several tags simultaneously using anti-collision technology as is known in the art. Furthermore, each patient 414 within the facility will also have a tag assigned to them, preferably, in the form of a wristband 416.

It is to be appreciated that RFID tags are low-cost, reprogrammable and disposable making them efficient and cost effective for health care use. For example, RFID tags employed for patient wristbands allow their disposal after each use preventing re-use of RFID wristbands and possible spread of matter. Furthermore, since the RFID tags are reprogrammable, e.g., read/write capable, the tags can be reutilized when equipment is expended and disposed of.

It is to be further appreciated that the system 200 may use other existing technologies to determine the quantity and locations of required equipment. For example, tags 408, 412 may be barcode labels and reader 404 may be a wireless reader interacting with a wireless, handheld scanner. In another example, the system 200 may utilizes existing CCD cameras, i.e., from the facilities surveillance system, and employed object identification technology to determine the locations of the equipment; in this scenario, the system 200 may recognize the whole piece of equipment without a tag or may just recognize the tag. Other object recognition technologies are contemplated.

When utilizing the system 200, initially in step 502, an id of the patient 414 is determined. This may be accomplished by scanning the patient's tag 416 with a handheld device that relays the id to the reader 404, e.g., a barcode scanner, or, if the patient is within the range of the reader, the reader 404 will retrieve the id from the patient tag 416 itself, e.g., an RFID tag. Each patient tag is a user-specific tag having a unique user identification code. Furthermore, the id of the patient may be determined by face recognition technology utilizing a self-contained CCD camera and server with the appropriate software. The reader 404, or other appropriate device, will then transmit the patient's id, via an identification signal, over bus 402 to the configuration system 200.

Based on the patient's id, the system 200 will retrieve the patient's record from the patient record database 202 (step 504). From the patient's record, the system will determine the clinical guideline prescribed for the patient and retrieve the guideline from the clinical guideline database 204 (step 506). The system 200 will then determine the current step in the guideline for this patient (step 508). Alternatively, besides determining the current state of the patient from the prescribed guideline, the system 200 can determine the patient's current state simply from the patient record or the system 200 may interact with departmental information systems to retrieve ordered procedures and, in turn, determine the patient's current state from the procedures ordered. Based on the step in the guideline or the patient's current state, the system will retrieve the recommended care setting configuration for current step from the care setting configuration database 206 (step 510).

In step 512, the system 200 will determine the current setting of the patient by scanning the tags associated with the equipment in the patient's setting. For example, reader 404 will read tags 420 and 424 associated with equipment 418 and 422, respectively, in patient room # 2. The system 200 will then compare the recommended configuration with the existing configuration, in step 514. If the configurations match, no further action will need to be taken and, preferably, the system 200 will notify a user of the same (step 516). However, if the configurations do not match, the system 200 will propose alternate configuration or may propose the minimum changes required so have the configuration conform (step 518). In proposing the alternative configuration, the system 200 may transmit a work order to the ordering/scheduling system 210 to have equipment removed from the patient's current setting and have the required equipment moved in. Furthermore, the ordering/scheduling system may generate a purchase order if the necessary medical equipment is not available at the facility. The ordering/scheduling system 200 may be a standalone system coupled to the configuration system 200 via bus 402 or may be a software application executing on the configuration system 200.

It is contemplated that the system 200 may incorporate software and hardware having “what-if” capabilities to simulate various alternative steps to be taken for a prescribed guideline. A system including such capabilities is disclosed in co-pending U.S. Patent Application entitled “DECISION SUPPORT SYSTEM FOR SIMULATING EXECUTION OF AN EXECUTABLE CLINICAL GUIDELINE”, Docket No. US040265, U.S. Application Ser. No. 60/591,071, filed Jul. 26, 2004, simulating various approaches and outcomes to the patient, the system 200 of the present disclosure can support resource planning by providing hints to the supply chain management system about the projected needs of the patient and facility.

A system and method for configuring a clinical setting for a particular patient according to a clinical guideline prescribed for the particular patient have been described. Advantageously, the system and method of the present disclosure enable efficient resource (e.g., medical equipment) planning and scheduling; helps to increase productivity at a time of critical personnel shortages; and ensures clinical staff satisfaction with the coordination between the progression of the patient through the clinical guideline and the configuration of care location. Furthermore, the system and method enables the clinical staff to spend more time with the patient, rather than figuring out what is needed (devices, resources) to render the proper care for the particular patient at the appropriate time.

It is to be appreciated that the system and method of the present disclosure is modular. For example, it can be applied to a single hospital room, or to a healthcare enterprise. Further, it can be applied at public places such as hotels, stadiums, or even cities to help manage a coordinated response to terrorist attacks. It can be extended to war zones. In these large scale scenarios, GPS (Global Positioning System) tags may be used in addition to RFID tags. It is also contemplated in the large scale scenario that the system employ a WiFi system, operating under the 802.11 standard, coupled to the Internet. While the invention has been shown and described with reference to certain preferred embodiments thereof, it will be understood by those skilled in the art that various changes in form and detail may be made therein without departing from the spirit and scope of the disclosure as defined by the appended claims.

1. A method for configuring a clinical care setting for at least one patient, the method comprising the steps of:
retrieving a clinical guideline prescribed for the at least one patient (506);
determining a care setting configuration based on the retrieved clinical guideline (510);
comparing the determined care setting configuration with a current care setting configuration of the at least one patient (514); and
proposing alternate care setting if the determined care setting configuration does not match the current care setting configuration of the at least one patient (518).

2. The method as in claim 1, wherein the retrieving a clinical guideline comprises the steps of:
obtaining an identification of the at least one patient (502);
retrieving a data record of the at least one patient based on the patient identification (504); and
determining the clinical guideline prescribed for the at least one patient based on the patient record (506).

3. The method as in claim 2, wherein the obtaining step includes detecting a user-specific tag having a unique user identification code.

4. The method as in claim 3, wherein the user-specific tag is a radio frequency identification (RFID) tag.

5. The method as in claim 2, wherein the obtaining step includes scanning a barcode having a unique user identification code.

6. The method as in claim 2, wherein the obtaining step includes identifying the at least one patient by face recognition.

7. The method as in claim 1, wherein the determining step further comprises the steps of:
determining a current step in the clinical guideline for the at least one patient based on the patient record (508); and
selecting the determined care setting configuration based on the current step in the clinical guideline (510).

8. The method as in claim 1, wherein the comparing step further comprises the steps of:
obtaining the current care setting configuration by detecting at least one tag associated with at least one piece of medical equipment (512).

9. The method as in claim 8, wherein the at least one tag is a radio frequency identification (RFID) tag.

10. The method as in claim 1, wherein if the determined care setting configuration matches the current care setting configuration of the at least one patient, indicating to a user the current care setting is satisfactory (516).

11. The method as in claim 1, wherein the proposing step further comprises generating a work order for required equipment based on the determined configuration (518).

12. A system (200) for configuring a clinical care setting for at least one patient, the system comprising:
at least one contactless reader (404) for detecting a first tag associated with a patient (416) and generating a first identification signal indicative of the first tag; and
a processor (302) for receiving the first identification signal, retrieving a patient record based on the first identification signal and generating a clinical care setting configuration for the patient based on the patient record.

13. The system (200) as in claim 12, wherein the system further comprises a clinical guideline database (204) for storing a plurality of clinical guidelines, and wherein the processor (302) retrieves a prescribed clinical guideline for the patient based on the patient record.

14. The system (200) as in claim 13, wherein the system further comprises a care setting configuration database (206), and wherein the processor (302) determines a current step of the clinical guideline for the patient based on the patient record and generates the clinical care setting based on the current step of the clinical guideline.

15. The system (200) as in claim 12, wherein the at least one reader (404) detects at least one second tag associated with at least one piece of medical equipment (408, 412) and the processor (302) determines a current care setting configuration based on the detected at least one second tag (408, 412), and wherein the processor (302) determines if the generated care setting configuration matches the current care setting configuration.

16. The system (200) as in claim 15, wherein the first and at least one second tags are radio frequency identification (RFID) tags.

17. The system (200) as in claim 15, wherein the first and at least one second tags are global positioning system (GPS) tags.

18. The system (200) as in claim 15, further comprising an ordering system (210) for ordering necessary medical equipment if the processor determines the generated care setting configuration does not match the current care setting configuration.

19. The system (200) as in claim 15, further comprising a scheduling system (210) for scheduling rearrangement of necessary medical equipment if the processor determines the generated care setting configuration does not match the current care setting configuration.

20. A program storage device readable by a machine, tangibly embodying a program of instructions executable by the machine to perform method steps for configuring a clinical care setting for at least one patient, the method steps comprising:
retrieving a clinical guideline prescribed for the at least one patient;
determining a care setting configuration based on the retrieved clinical guideline;
comparing the determined care setting configuration with a current care setting configuration of the at least one patient; and
proposing an alternate care setting if the determined care setting configuration does not match the current care setting configuration of the at least one patient.
